(19) United States
(12) Patent Application Publication
(10) Pub. No.: US 2022/0343903 A1
(43) Pub. Date: Oct. 27, 2022

(54) Data-Informed Decision Making Through a Domain-General Artificial Intelligence Platform

(71) Applicant: Verneek, Inc., Princeton, NJ (US)

(72) Inventors: Nasrin Mostafazadeh, Princeton, NJ (US); Omid Bakhshandeh, Princeton, NJ (US); Sam Anzaroot, Long Island City, NY (US)

(21) Appl. No.: 17/726,113

(22) Filed: Apr. 21, 2022

Related U.S. Application Data
(60) Provisional application No. 63/177,483, filed on Apr. 21, 2021.

(51) Int. Cl. G10L 15/16; G06N 5/02; G06F 40/30; G10L 13/08

(52) U.S. Cl. CPC G10L 15/16; G06N 5/02; G06F 40/30; G10L 13/08

(57) ABSTRACT

A domain-general artificial intelligence platform or system and methods that enable data-informed decision making for anyone without the need for any coding ability are disclosed. This artificial intelligence platform has domain-generality, interoperability across heterogeneous sources of data, and controllability by tracking provenance. The artificial intelligence platform works by receiving a natural language query, converts the natural language query into executable code grounded in the deep semantic understanding of the underlying data, using a natural language artificial intelligence engine, runs the executable code on a distributed runtime engine to generate data output, and augments the data with a generated natural language report which becomes the ultimate output to the user.

### CROSS-REFERENCE TO RELATED APPLICATIONS

The present application claims priority, under 35 U.S.C. § 119, of U.S. Provisional Patent Application No. 63/177,483, filed Apr. 21, 2021 and entitled “Data-Informed Decision Making Through a Domain-General Artificial Intelligence Platform,” which is incorporated by reference in its entirety.

### FIELD OF THE DISCLOSURE

The present disclosure relates to domain-general artificial intelligence (AI) platform that enables data-informed decision making in any domain, for anyone, without needing to code.

### BACKGROUND

Users generate quintillion bytes of data everyday. Leveraging this data for faster and better decision making through data for societal, personal, and business matters is more viable and crucial than ever. Currently there is no way to effectively use data for every-day decision making, at all occasions. The average person has to jump through various silos in order to make decisions that are rarely influenced by data, which results in extremely un-deterministic, time-consuming, and inaccurate decision making. The current tools in the market that enable using data are mainly designed for a tiny fraction of people with highly technical backgrounds who can code. The unavailability of AI and data science tools to non-technical people has limited the extra-ordinary potential value that could be generated from data.

Two common scenarios in the current world: Scenario 1: you are a business stakeholder, and have a business question in mind that relates to your business data. Even if you are lucky enough to have an in-house data science team, the following is the process for getting an answer to your question: a) defining the question, b) giving the questions to your technical data team, c) get the answer back in days or even weeks. This process is clearly inefficient, time-consuming, prone to compounding errors, and needs to be repeated for every single new question. Imagine all the wrong business decisions that could have been prevented if business stakeholders could instantaneously get answers to their questions. Of course, most business stakeholders do not even have access to a technical data science team, since it is often costly to hire and maintain one. These smaller businesses are continually losing their livelihood to the larger corporations who are getting ahead by making better and faster business decisions through the massive data. The current data science pipeline is broken. One of the major problems which has been the barrier to entry to data science has been its interface: the programming languages.

Scenario 2: you are responsible for shopping for food items and cooking meals for your family. You have some new financial constraints and one of your children just got diagnosed with being histamine intolerant. You have to find out what food items are low histamine, find good recipes that do not have them, among prior restrictions of your family, then find the closest items in your neighborhood stores that are also the cheapest options. Clearly, this journey involves going through various disconnected siloes, for manual research and discovery, which makes up quite an inconvenient and time-consuming, not to name error-prone, decision-making process.

### SUMMARY

According to one innovative aspect of the subject matter described in this disclosure, a system comprises one or more processors and a memory, the memory storing instructions, which when executed cause the one or more processors to perform operations including receiving a natural language query; optionally receiving a domain selection and external data, converting the natural language query into executable code grounded on the deep semantic understanding of the data, using a natural language artificial intelligence engine; running the executable code; generating an output based upon running the executable code; and providing a multimodal output to the user. The system provides controllability by tracking provenance.

In general, another innovative aspect of the subject matter described in this disclosure may be implemented in methods that include receiving, using one or more processors, a natural language query; converting, using one or more processors, the natural language query into executable code using a natural language artificial intelligence engine; running, using one or more processors, the executable code; generating an output based upon running the executable code; and providing the output to the user. The system provides controllability by tracking provenance.

Other implementations of one or more of these aspects include corresponding systems, apparatus, and computer programs, configured to perform the actions of the methods, encoded on computer storage devices.

These and other implementations may each optionally include one or more of the following features. In one example, the natural language query includes one or more of text, speech or text and speech. For instance, the operations further include receiving a selection of a domain from the user; receiving external data; performing deep semantic data composition using the selected domain and the external data. In some instances, the performing deep semantic data composition comprises: learning a canonical data representation for the selected domain; receiving one or more teaching actions; automatically transforming a data schema of the selected domain to the canonical data representation using the one or more teaching actions; outputting teaching actions based on the transformed data schema; outputting structured data and the transformed schema; and generating curated facts and knowledge graphs by machine reading of unstructured data. For example, the outputting teaching actions includes generating specific teaching actions or instances using human-in-the-loop machine learning. In some instances, the operation of converting the natural language query into executable code comprises: performing neural question answering e given the natural language query; performing neural semantic processing given the natural language query; performing deep information retrieval using the natural language query; and generating a natural language response from the aggregate response from the dialog manager. In some instances, converting the natural language query into executable code comprises performing speech recognition on the natural language query to generate text. For instance, the operations of generating an output based on running the executable code may further include receiving a text query based on the natural language query; classifying a query intention category for the text query; receiving a natural language data report; classifying result type based on the natural language data report; receiving an execution result; generating a visualization type based on the execution result and the execution result type; and generating a visualization based upon the visualization type and the execution result. Finally, in some implementations, generating the output includes generating an interactive report.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example implementation of a system including domain-general artificial intelligence platform that enables data-informed decision making for anyone.

FIG. 2A is a block diagram of an example server including the domain-general artificial intelligence platform along with its various components.

FIG. 2B is a block diagram of an example implementation of domain-general artificial intelligence platform in accordance with the present disclosure.

FIG. 3 illustrates a block diagram of an example AI-enabled visualization and reporting engine of the domain-general artificial intelligence platform in accordance with the present disclosure.

FIG. 4 is a block diagram of an example implementation for the Natural Language AI Engine in accordance with the present disclosure.

FIG. 5 is a block diagram of an example implementation for the Human-in-the-loop machine learning (ML) module in accordance with the present disclosure.

FIG. 6 is a block diagram of an example implementation for the distributed run time engine in accordance with the present disclosure.

FIG. 7 is a block diagram of an example implementation for the AI-enabled deep semantic data decomposition system in accordance with the present disclosure.

FIG. 8 is a block diagram of an example implementation for the data warehouse in accordance with the present disclosure.

FIG. 9 is a flowchart of an example method for data-informed decision making in accordance with the present disclosure.

FIG. 10 is a flowchart of an example method for deep semantic data composition in accordance with the present disclosure.

FIG. 11 is a flowchart of an example method for converting a query into executable code using neural semantic parsing in accordance with the present disclosure.

FIG. 12 is a flowchart of an example method for AI-enabled visualization in accordance with the present disclosure.

### DETAILED DESCRIPTION

As noted above, the present disclosure relates to a domain general artificial intelligence platform or system 150 that enables data-informed decision making. The domain general artificial intelligence platform or system 150 uses various AI technologies to enable anyone, without the need for any coding ability, to easily make better and faster decisions through data, to better manage their business/personal matters. In particular, the domain-general AI platform comprises various components which together make it possible to replace programming languages (coding) with speech/text input and other intuitive modalities of interaction for interacting with heterogeneous sources of data in any domain that essentially automate the entire data science pipeline (including research and discovery for data) using AI, thereby, making data-informed decision making accessible to any user even though the user does not have any technical specialty. As described herein, the domain general artificial intelligence platform or system 150 provides innovative human-machine interfaces that enable any user to seamlessly onboard any public/private data sources and to perform various actions needed for data-informed decision making, such as research and discovery through the past data and making predictions for the future. The entire process is as intuitive as onboarding and processing the desired dataset(s) using the interactive user interface (UI) and then proceeding to asking desired questions in natural language. It should be understood that while the present disclosure will be described below primarily for the English language, the underlying AI technologies may be applied to any other language. The domain general AI platform or system 150 provides a natural language understanding and dialogue engine, answering questions about any kind of underlying data. The domain general AI platform or system 150 advantageously receives natural language or dynamic language input in free-form, does not require pre-defined templates or predefined patterns, and generates interactive reports as answers to queries.

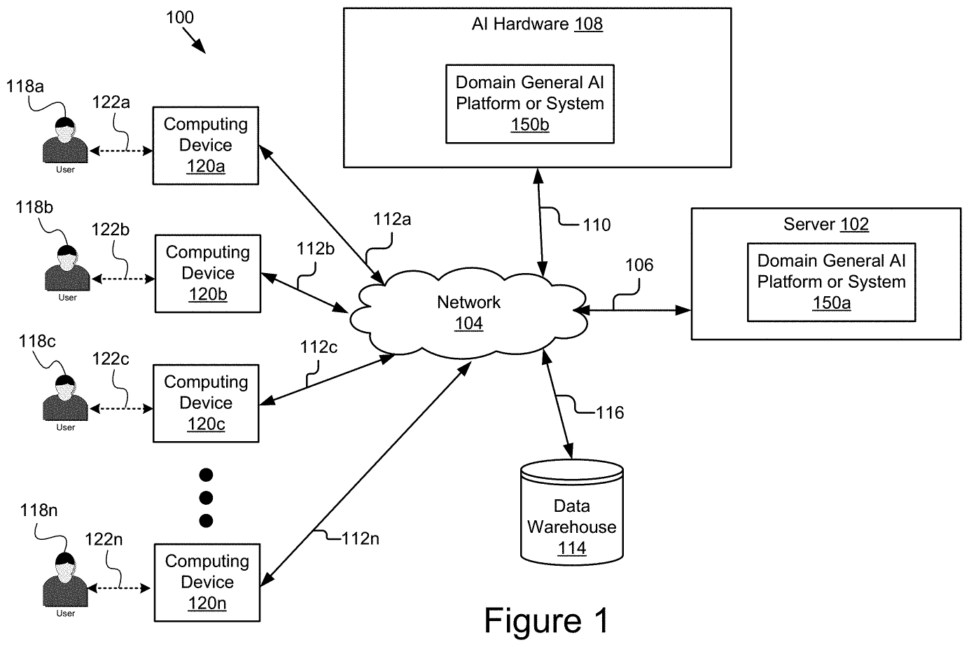

FIG. 1 is a block diagram of an example implementation of a system 100 including a domain general AI platform or system 150. In the description below, a letter after a reference number, e.g., “150a,” represents a reference to the element having that particular reference number. A reference number in the text without a following letter, e.g., “150,” represents a general reference to instances of the element bearing that reference number. As depicted, the system 100 includes a server 102 and one or more computing devices 120a . . . 120n coupled for electronic communication via a network 104, AI hardware 108, and a data warehouse 114. Each computing device 120 may be associated with a data channel 122a-n, such as an application running on a mobile device, a user's specific computer, a computer in a specific location, etc. These data channels 122a-n may collect data and/or queries related to one or more users 118a . . . 118n and provide data and/or queries to the network 104, such as via signal lines 112a . . . 112n. For example, the user 118 may select a domain or a data source and also input voice or text queries and receive responses back as indicated by the channels 122a-122n. In FIG. 1, a letter after a reference number, e.g., “120a,” represents a reference to the element having that particular reference number. A reference number in the text without a following letter, e.g., “120,” represents a general reference to instances of the element bearing that reference number. It should be understood that the system 100 depicted in FIG. 1 is provided by way of example and the system 100 and/or further systems contemplated by this present disclosure may include additional and/or fewer components, may combine components and/or divide one or more of the components into additional components, etc. For example, the system 100 may include any number of computing devices 120, data stores or data warehouses 114, networks 104, or servers 102.

The network 104 may be a conventional type, wired and/or wireless, and may have numerous different configurations including a star configuration, token ring configuration, or other configurations. For example, the network 104 may include one or more local area networks (LAN), wide area networks (WAN) (e.g., the Internet), personal area networks (PAN), public networks, private networks, virtual networks, virtual private networks, peer-to-peer networks, near field networks (e.g., Bluetooth®, NFC, etc.), and/or other interconnected data paths across which multiple devices may communicate.

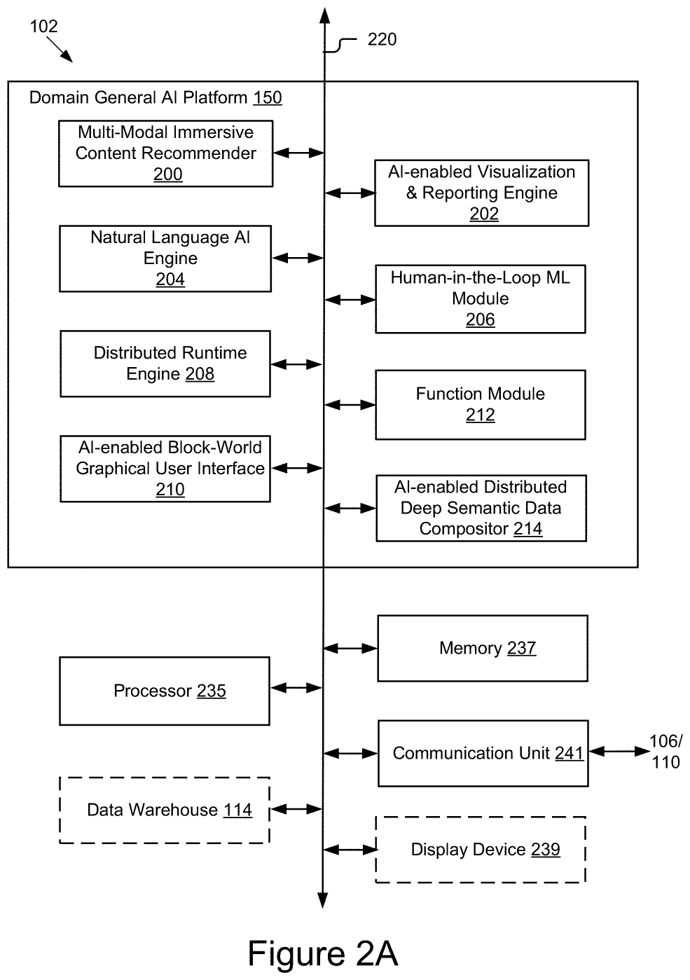

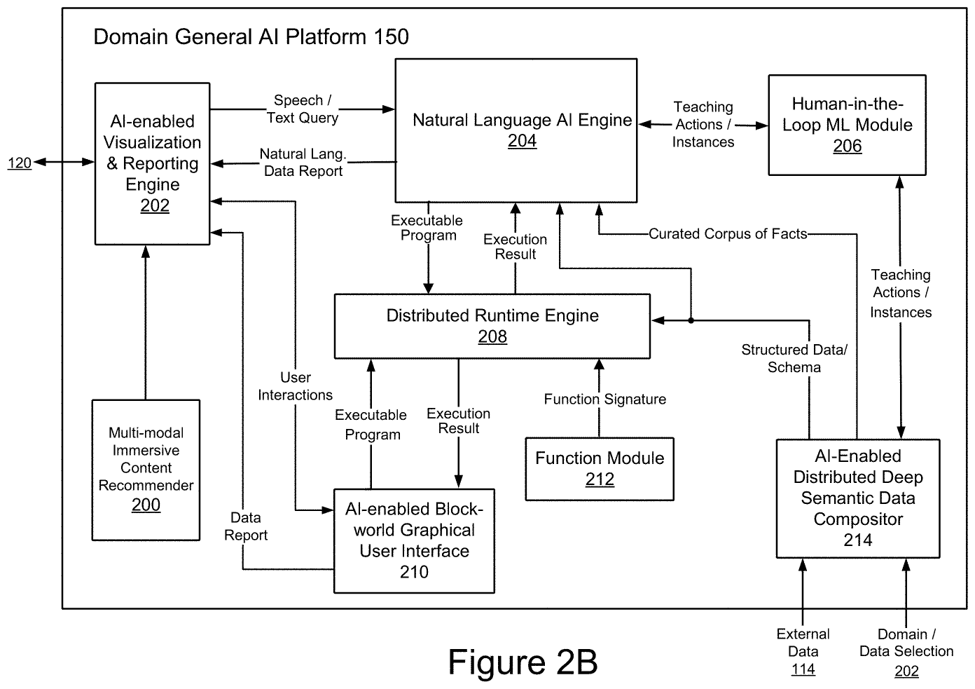

The server 102 includes a hardware and/or virtual server that includes a processor, a memory, and network communication capabilities (e.g., a communication unit), as will be described in more detail below with reference to FIGS. 2A and 2B. The server 102 may be communicatively coupled to the network 104, as indicated by signal line 106. In some implementations, the server 102 may send and receive data to and from other entities of the system 100 (e.g., one or more of the computing devices 120). As depicted, the server 102 may include the domain general AI platform or system 150 as described herein.

The AI hardware 108 is dedicated hardware and may include some or all of the same functionality as the domain general AI platform or system 150b. As shown in FIG. 1, the AI hardware 108 is coupled by signal line 110 to the network 104 for communication the computing devices 120a-120n, the server 102 and the data warehouse 114. In one implementation, the AI hardware 108 may be a stand-alone device that includes all the functionality of the domain general AI platform or system 150b as will be described below. For example, the AI hardware 108 may be part of a custom-designed kiosk that is placed in a retail store such as a grocery store, a warehouse store, a drugstore, convenience store, a specialty store or a department store. More specifically, the custom-designed kiosk may include a computing device including an input device, an output device, a processor, memory, storage and network connection. In another implementation, the AI hardware 108 is a dedicated hardware device with a thin client that communicates and interfaces with the domain general AI platform or system 150a of the server 102 to perform the operations that described below. In yet another implementation, the AI hardware 108 includes particular functionality of the domain general AI platform or system 150 that allows it to process input and prepare them for AI analysis and processing to reduce the communication bandwidth needed between the AI hardware 108 and the server 102. It should be understood that the functionality of the domain general AI platform or system 150 may be divided between the AI hardware 108, the server 102 and the computing device 120 in various different implementations and amounts.

The data warehouse 114 stores various types of data for access and/or retrieval by the domain general AI platform or system 150. It should be understood that the data may be in any shape or form, e.g., all the way from spurious spreadsheets in CSV format to a relational database such as SQL unstructured web-scale text and images, data from streaming or on-line from API calls, or the like. For example, the data warehouse 114 may store user data associated with various users, public or proprietary data for training AI or ML models, and other data which will be further described below. The user data may include a user identifier (ID) uniquely identifying the users, a user profile, one or more data metrics of the users corresponding to data received from one or more channels. Other types of user data are also possible and contemplated. The data warehouse 114 is a non-transitory memory that stores data for providing the functionality described herein. In some implementations, the data warehouse 114 is coupled by signal line 116 to the network 104 for communication and data exchange with the computing device 120 the AI hardware 108 and the server 102. The data warehouse 114 may be included in the computing device 120 or in another computing device and/or storage system (not shown) distinct from but coupled to or accessible by the computing device 120. The data warehouse 114 may include one or more non-transitory computer-readable mediums for storing the data. In some implementations, the data warehouse 114 may be incorporated with the memory 237 or may be distinct therefrom. In some implementations, the data warehouse 114 may be storage, a dynamic random-access memory (DRAM) device, a static random-access memory (SRAM) device, flash memory, or some other memory devices. In some implementations, the data warehouse 114 may include a database management system (DBMS) operable on the computing device 120. For example, the DBMS could include a structured query language (SQL) DBMS, a NoSQL DBMS, various combinations thereof, etc. In some instances, the DBMS may store data in multi-dimensional tables composed of rows and columns, and manipulate, e.g., insert, query, update and/or delete, rows of data using programmatic operations. In other implementations, the data warehouse 114 also may include a non-volatile memory or similar permanent storage device and media including a hard disk drive, a CD-ROM device, a DVD-ROM device, a DVD-RAM device, a DVD-RW device, a flash memory device, or some other mass storage device for storing information on a more permanent basis. The data warehouse 114 is communicatively coupled to the bus 220. The data warehouse 114 may store, among other data, the trained machine learning (ML) models, and the application metadata and transaction data.

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server to a client, or vice versa, data may be consolidated into a single data store or further segmented into additional data stores or data warehouses, and some implementations may include additional or fewer computing devices, services, and/or networks, and may implement various functionality client or server-side. Furthermore, various entities of the system may be integrated into a single computing device or system or divided into additional computing devices or systems, etc.

FIG. 2A is a block diagram of the server 102 including the domain general AI platform or system 150. In this example, the server 102 is a hardware server. The server 102 may also include a processor 235, a memory 237, a display device 239 (optional as indicated with dashed lines), a communication unit 241, and a data warehouse 114 (optional as indicated with dashed lines), according to some examples. The components of the server 102 are communicatively coupled by a bus 220. The bus 220 may represent one or more buses including an industry standard architecture (ISA) bus, a peripheral component interconnect (PCI) bus, a universal serial bus (USB), or some other bus known in the art to provide similar functionality.

The processor 235 may execute software instructions by performing various input/output, logical, and/or mathematical operations. The processor 235 may have various computing architectures to process data signals including, for example, a complex instruction set computer (CISC) architecture, a reduced instruction set computer (RISC) architecture, and/or an architecture implementing a combination of instruction sets. The processor 235 may be physical and/or virtual, and may include a single processing unit or a plurality of processing units and/or cores. In some implementations, the processor 235 may be capable of generating and providing electronic display signals to a display device, supporting the display of images, capturing and transmitting images, and performing complex tasks. In some implementations, the processor 235 may be coupled to the memory 237 via the bus 220 to access data and instructions therefrom and store data therein. The bus 220 may couple the processor 235 to the other components of the server 102 including, for example, the memory 237, the communication unit 241, the domain general AI platform or system 150, and the data warehouse 114. It will be apparent to one skilled in the art that other processors, operating systems, sensors, displays, and physical configurations are possible.

The memory 237 may store and provide access to data for the other components of the server 102. The memory 237 may be included in a single computing device or distributed among a plurality of computing devices as discussed elsewhere herein. In some implementations, the memory 237 may store instructions and/or data that may be executed by the processor 235. The instructions and/or data may include code for performing the techniques described herein. For example, in one implementation, the memory 237 may store the domain general AI platform or system 150. The memory 237 is also capable of storing other instructions and data, including, for example, an operating system, hardware drivers, other software applications, databases, etc. The memory 237 may be coupled to the bus 220 for communication with the processor 235 and the other components of the server 102.

The memory 237 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 235. In some implementations, the memory 237 may include one or more of volatile memory and non-volatile memory. It should be understood that the memory 237 may be a single device or may include multiple types of devices and configurations.

The display device 239 is a liquid crystal display (LCD), light emitting diode (LED) or any other similarly equipped display device, screen or monitor. In some implementations, the display device 239 may be a touch screen with browsing capabilities. The display may or may not be touch-screen. The display device 239 represents any device equipped to display user interfaces, electronic images, and data as described herein. In different implementations, the display is binary (only two different values for pixels), monochrome (multiple shades of one color), or allows multiple colors and shades. The display device 239 is coupled to the bus 220 for communication with the processor 235 and the other components of the server 102. It should be noted that the display device 239 can be optional.

The communication unit 241 is hardware for receiving and transmitting data by linking the processor 235 to the network 104 and other processing systems. The communication unit 241 receives data such as user input from the computing device 120 and transmits the data to the AI-enabled visualization & reporting engine 202. The communication unit 241 also transmits instructions from the AI-enabled visualization & reporting engine 202 for displaying the user interface on the computing device 120, for example. The communication unit 241 is coupled to the bus 220. In one implementation, the communication unit 241 may include a port for direct physical connection to the computing device 120 or to another communication channel. For example, the communication unit 241 may include an RJ45 port or similar port for wired communication with the computing device 120. In another implementation, the communication unit 241 may include a wireless transceiver (not shown) for exchanging data with the computing device 120 or any other communication channel using one or more wireless communication methods, such as IEEE 802.11, IEEE 802.16, Bluetooth® or another suitable wireless communication method.

In yet another implementation, the communication unit 241 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another implementation, the communication unit 241 may include a wired port and a wireless transceiver. The communication unit 241 also provides other conventional connections to the network 104 for distribution of files and/or media objects using standard network protocols such as TCP/IP, HTTP, HTTPS, and SMTP as will be understood to those skilled in the art.

As depicted in FIG. 2A, in some implementations, the domain general AI platform or system 150 comprises: a multi-modal immersive content recommender 200, an AI-enabled visualization & reporting engine 202, a natural language AI engine 204, a human-in-the-loop ML module 206, a distributed runtime engine 208, an AI-enabled block-world graphical user interface 210, a function module 212 and an AI-enabled distributed deep semantic data compositor 214. The components 200, 202, 204, 206, 208, 210, 212 and 214 may be communicatively coupled by the bus 220 and/or the processor 235 to one another and/or the other components 237, 239, and 241, of the server 102 for cooperation and communication. The components 200, 202, 204, 206, 208, 210, 212 and 214 may each include software and/or logic to provide their respective functionality. In some implementations, the components 200, 202, 204, 206, 208, 210, 212 and 214 may each be implemented using programmable or specialized hardware including a field-programmable gate array (FPGA) or an application-specific integrated circuit (ASIC). In some implementations, the components 200, 202, 204, 206, 208, 210, 212 and 214 may each be implemented using a combination of hardware and software executable by the processor 235. In some implementations, each one of the components 200, 202, 204, 206, 208, 210, 212 and 214 may be sets of instructions stored in the memory 237 and configured to be accessible and executable by the processor 235 to provide their acts and/or functionality. In some implementations, the components 200, 202, 204, 206, 208, 210, 212 and 214 may send and receive data, via the communication unit 241, to and from one or more of the computing devices 120a-120n, and the third-party servers (not shown). The functionality, coupling and cooperation of these components 200, 202, 204, 206, 208, 210, 212 and 214 are described in more detail herein.

The multi-modal immersive content recommender 200 may include software and/or logic to provide the functionality for dynamically recommending contextual content, in the form of curated instructional or promotional videos, images, or text, that will help with decision making while the user is not actively asking questions. Some examples of the provided content include displaying fun facts about biology presented in the form of curated videos for students to learn in the education domain, or curated video recipes automatically tied to store products in the food retail domain, or curated workout instructional videos for alleviating back pain in the physical therapy domain, or curated dynamic images informing the user about the efficacy and safety of COVID-19 vaccines in the healthcare domain. The multi-modal immersive content recommender 200 is coupled to output data to the AI-enabled visualization & reporting engine 202. The multi-modal immersive content recommender 200 is described in more detail below with reference to FIG. 2B.

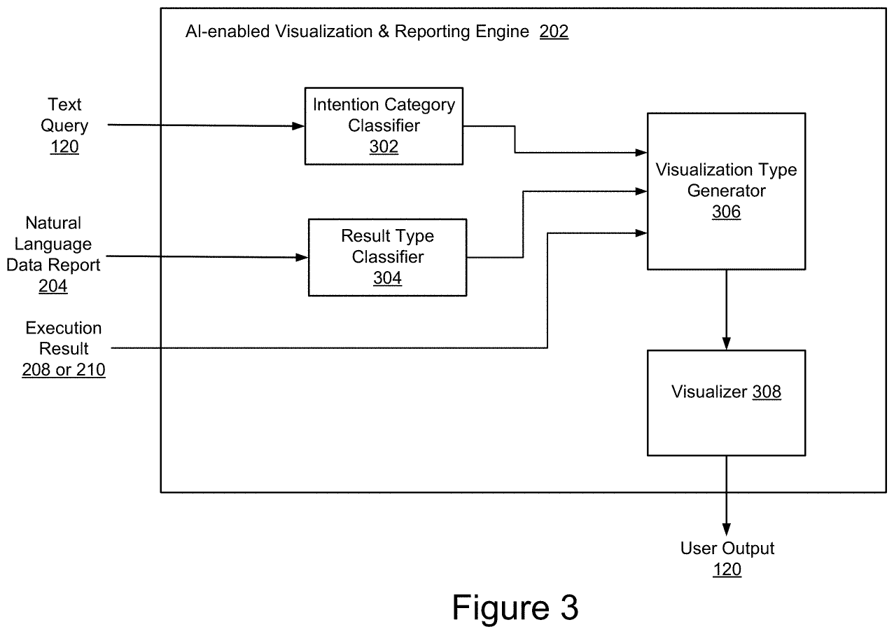

The AI-enabled visualization & reporting engine 202 may include software and/or logic to provide the functionality for intelligent visualization of the results from the natural language AI engine 204 and/or the AI-enabled block-world graphical user interface 210. The AI-enabled visualization & reporting engine 202 dynamically generates interactive custom reports to answer user queries in an intuitive way. This AI-enabled visualization & reporting engine 202 is described in more detail below with reference to FIGS. 2B and 3.

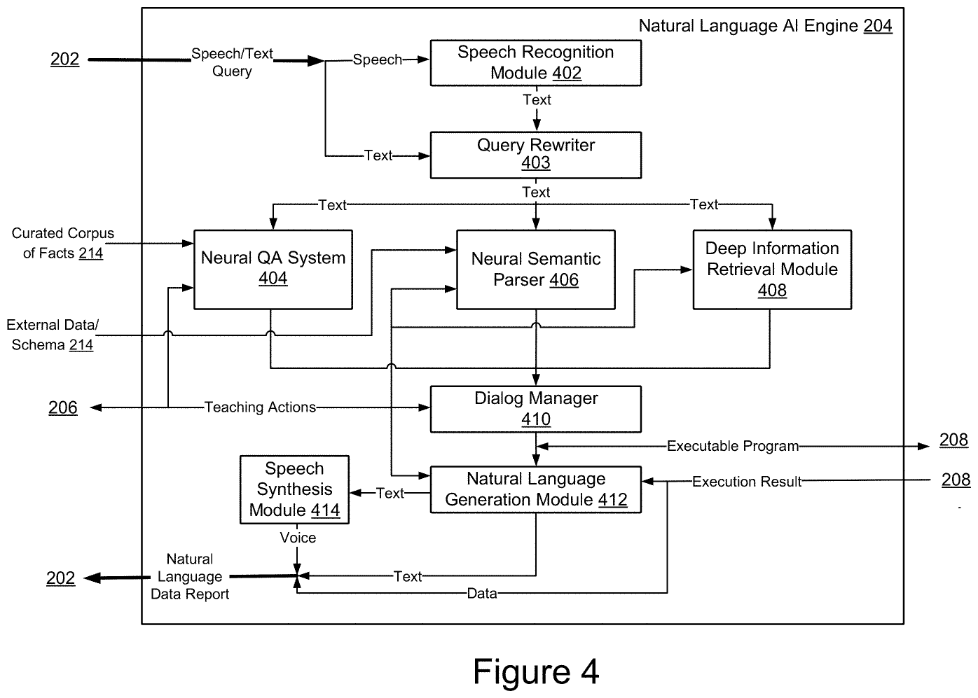

The natural language AI engine 204 may include software and/or logic to provide the functionality for deep semantic understanding of the user queries and turning the queries into an executable program, grounded in data, which is sent by the natural language AI engine 204 to the distributed runtime engine 208. Furthermore, the natural language AI engine 204 has natural language generation capabilities and is coupled for communication with the AI visualization & reporting engine 202. Some implementations of the natural language AI engine 204 are described in more detail below with reference to FIGS. 2B and 4.

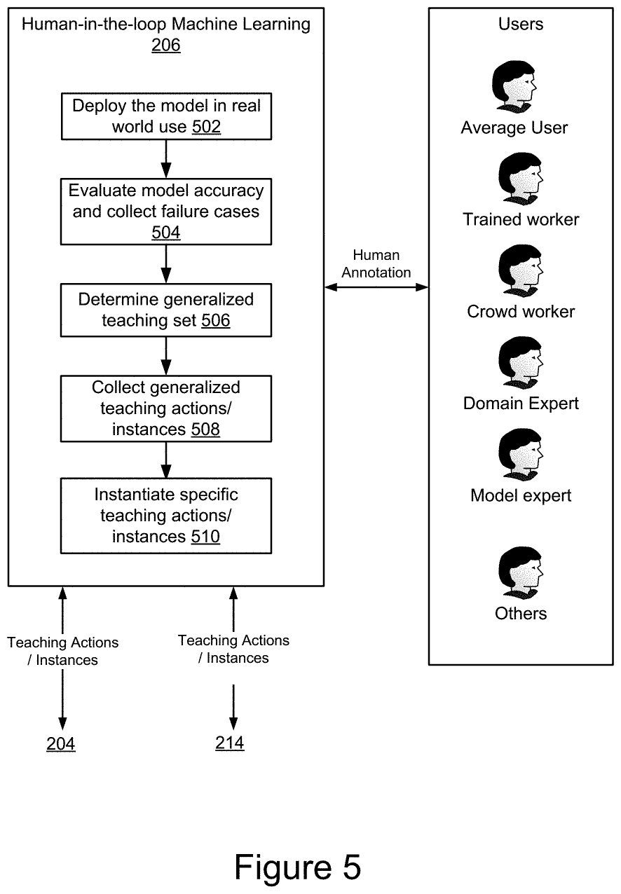

The human-in-the-loop ML module 206 may include software and/or logic to provide the functionality for combining the power of an intelligent human in the loop, as the teacher, with the domain general AI platform or system150 that learns to improve over time through efficiently interacting with its teacher. The human-in-the-loop ML module 206 provides some minimal supervision over the work of the systems. Some implementations of the human-in-the-loop ML module 206 are described in more detail below with reference to FIGS. 2B and 5.

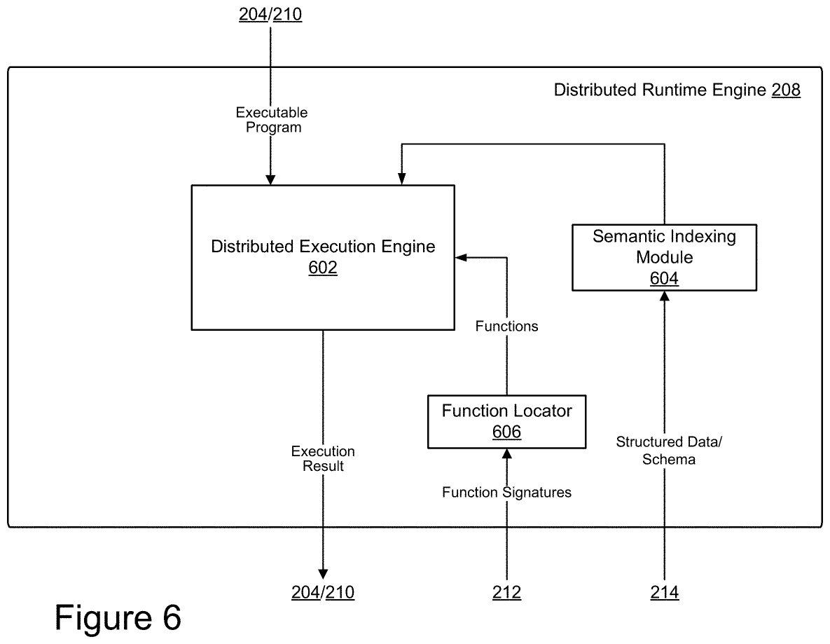

The distributed runtime engine 208 may include software and/or logic to run the executable program generated by the natural language AI engine 204 or the AI-enabled block-world graphical user interface 210 on top of heterogeneous sources of data. This distributed runtime engine 208 supports optimal data processing and interoperability, enabling the domain general AI platform or system 150 to scale. The distributed runtime engine 208 outputs the execution results to the natural language AI engine 204 and the AI-enabled block-world graphical user interface 210. Some implementations of the distributed runtime engine 208 are described in more detail below with reference to FIGS. 2B and 6.

The AI-enabled block-world graphical user interface 210 may include software and/or logic for an inter-connectable block-like interface that makes the creation of any complex data flow or new functionality, for various data ingestion or other custom functions, as easy as building a block structure, e.g., Lego® like. The AI-enabled block-world graphical user interface 210 is coupled to communicate with the distributed runtime engine 208 and the AI-enabled visualization & reporting engine 202. Some implementations of the AI-enabled block-world graphical user interface 210 will be described in more detail with reference to FIG. 2B.

The function module 212 may include software and/or logic that provides the available algorithmic blocks being functions (which could be domain-specific or domain-general) from public and private channels. These functions range from domain-general functionalities to complex domain-specific ones. Example domain-general functions include basic math functions such as add, subtract, or average, or basic data aggregation functions such as filtering or grouping of data records. Example domain-specific functions include a Net Present Value function that runs on the historical financial data in the finance domain, or a disease diagnostics function that runs on historical patient records to predict diseases in the healthcare domain, or a weather forecast function that returns predicted weather forecast in the meteorology domain, or an inventory forecast function that runs on historical customer purchases to predict out of stock items for a given store in the retail domain. The function module 212 is coupled to provide function signatures to the distributed runtime engine 208. Function signatures include an executable path to the functions along with typed inputs and outputs.

Referring now to FIG. 2B, one example implementation of the domain general AI platform or system150 is described. In particular, FIG. 2B illustrates example couplings, signals and data that are passed among the multi-modal immersive content recommender 200, the AI-enabled visualization & reporting engine 202, the natural language AI engine 204, the human-in-the-loop ML module 206, the distributed runtime engine 208, the AI-enabled block-world graphical user interface 210, the function module 212 and the AI-enabled distributed deep semantic data compositor 214. The domain general AI platform 150 addresses the problem of scalability by leveraging transfer learning as the learning paradigm for training of the AI and AI-enabled modules 202, 204, 210 and 214. The domain general AI platform 150 advantageously learns to generalize and scale its various modules, from a particular domain to another, by having each module pre-trained on the most general domain. The pretrained versions of the modules come imbued with fundamental linguistic, visual, world, and commonsense knowledge, which are domain-agnostic. These components are then orchestrated to allow the domain general AI platform or system 150 to collect high-quality targeted data sets in new domains over time and automatically train fine-tuned AI modules for various underlying tasks.

The multi-modal immersive content recommender 200 is coupled to provide dynamic and contextual recommended content to the AI-enabled visualization & reporting engine 202 to enable better decision-making while the user is not actively asking questions. Examples include dynamically recommending curated video recipes linked to the specific store products that satisfy the user's health constraints in the food retail domain, or curated health tips for a patient with particular chronic diseases at a health clinic.

The AI-enabled visualization & reporting engine 202 is coupled for communication and interaction with the computing device 120 of the user 118, the natural language AI engine 204, the AI-enabled block-world graphical user interface 210, and the multi-modal immersive content recommender 200. As noted above, the AI-enabled visualization & reporting engine 202 receives dynamic and contextual recommended content from the multi-modal immersive content recommender 200. The AI-enabled visualization & reporting engine 202 is also coupled by the network 104 to the computing device 120 of the user 118. The domain general AI platform or system 150 is particularly advantageous because it, via the AI-enabled visualization & reporting engine 202, receives natural language text/speech queries from the user for performing various decision-making actions such as querying/analyzing the existing data, or projections into the future. The AI-enabled visualization & reporting engine 202 is also coupled to send and receive user interactions from the AI-enabled block-world graphical user interface 210. The AI-enabled visualization & reporting engine 202 is also coupled to the natural language AI engine 204 to provide speech and text queries, and to receive a natural language data report. As shown in FIG. 2B, the AI-enabled visualization & reporting engine 202 is also coupled to provide the domain and data selection by the user to the AI-enabled distributed deep semantic data compositor 214.

Referring now also to FIG. 3, an example implementation of the AI-enabled visualization & reporting engine 202 is shown. The AI-enabled visualization & reporting engine 202 further comprises: an intention category classifier 302, a results category classifier 304, a visualization type generator 306 and a visualizer 308. In some implementations, all these components are implemented as different software modules and process the data received as indicated below. The intention category classifier 302 is coupled to receive a text query from the user via the computing device 120 and processes the text query to identify an intention type from a series of intention category classifications. The intention categories vary per domain, dictating domain-specific visualization requirements. For example, the intention categories in the shopping domain may include the following: product location and availability, price and discounts for products, general product information, recipes and wine related questions, general customer service questions, and health and well-being questions. The intention category classifier 302 is coupled to output the intention category that it identifies to the visualization type generator 306. The result category classifier 304 is coupled to receive the natural language data report from the natural language AI engine 204. The result category classifier 304 processes the natural language data report and generates an execution result type from the natural language data report. The execution result type may be any one of a plurality of different execution result type classes. The result category classifier 304 outputs the identified execution result type to the visualization type generator 306. The visualization type generator 306 also receives the execution result from the AI-enabled block world graphical user interface 210 or directly (not shown) from the distributed runtime engine 208. The visualization type generator 306 uses the identified intention type, the identified result type and the execution result to determine the best visualization type for presenting the results to the user. For example, visualization types may include different types of charts, graphs, tables, images, videos, and other information presentation types. The visualization type generator 306 is coupled to provide the identified visualization type as well as the execution result to the visualizer 308. The visualizer 308 generates a user output that includes the execution result as well as it presented and formatted in a display format that most effectively conveys the execution result to the user and that will be most easily understood by the user. The visualizer 308 is coupled to provide its output to the computing device 120 of the user 118.

Referring back to FIG. 2B, the interaction of the natural language AI engine 204 with other components of the domain general AI platform or system 150 are described. As noted above, the natural language AI engine 204 is coupled to the AI enabled visualization & reporting engine 202 to provide the natural language data report and to receive speech and text queries received from the user that are passed to the natural language AI engine 204. The natural language AI engine 204 is also coupled to the runtime engine 208 to provide the executable program and to receive the execution result, the result of running the executable program on given external data and a domain. The natural language AI engine 204 is also coupled to send requests for teaching action/instances and in response receive teaching action/instances from the human-in-the-loop ML module 206. Finally, the natural language AI engine 204 is coupled to the AI enabled distributed deep semantic data compositor 214 to receive curated corpus of facts, structured data and schema. The natural language AI engine 204 enables instantaneous access to the capabilities of the domain general AI platform or system 150, by using natural language. The natural language AI engine 204 supports both voice and text inputs. The natural language AI engine 204 learns to automatically generate executable programs from any given natural language input, grounded in the deep understanding of the underlying data. Furthermore, the natural language AI engine 204 produces a natural language report, in response to the user query, which gets handed to the AI-enabled visualization & reporting engine 202.

Referring now also to FIG. 4, an example implementation for the natural language AI engine 204 is shown and described in more detail. The natural language AI engine 204 advantageously parses queries and converts them to an executable program which gets executed on various data sources by the distributed runtime engine 208 as will be described in more detail below. In the implementation shown in FIG. 4, the natural language AI engine 204 comprises: a speech recognition module 402, a query rewriter module 403, neural question answering (QA) system 404, a neural semantic parser 406, a deep information retrieval module 408, a dialogue manager 410, a natural language generation module 412, and a speech synthesis module 414. The natural language AI engine 204 orchestrates handing the input query down the three various systems, with varying degrees of precision and recall. These systems are the neural QA system 404, the neural semantic parser 406, and the deep information retrieval module 408. Each of these modules 404, 406, and 408 output a confidence score tied to their predictions to the dialog manager 410. The dialog manager 410 is in charge of tracking the state of the ongoing dialog and making a decision as to the best next response to the user, given the historical context of the dialog. The dialog manager 410 has a specialized thresholding algorithm based on the confidence scores for deciding on what to output from each module 404, 406, and 408. These thresholds, learned jointly, are one of the hyperparameters that get tuned throughout the system 150, with the objective of increasing the system's F-score, which is the harmonic mean of the precision and recall of each module 404, 406, and 408. The speech recognition module 402 and the query rewriter 403 are coupled to receive speech and text queries from the AI-enabled visualization & reporting engine 202. Any speech queries are routed to the neural speech recognition module 402 which processes the speech and converts it to text which is output by the speech recognition module 402 to the query rewriter 403. The query rewriter 403 combines the text from the AI-enabled visualization & reporting engine 202 and the text from the speech recognition module 402 and uses them to generate a new more accurate query that is void of any vocabulary mismatch in the underlying domain. This new query is then provided to the neural QA system 404, the neural semantic parser 406, and the deep information retrieval module 408. In addition to the text query, the neural QA system 404 also receives corpora of curated facts from the AI-enabled Distributed Deep Semantic Data Compositor 214, and teaching actions and instances from the human-in-the loop ML 206. The neural QA system 404 is a retrieval augmented generation model that is trained to dynamically retrieve or generate factual responses to novel queries based on the corpora of curated facts, providing provenance for its decisions. The neural QA system 404 first performs a top-K neural retrieval to find the closest relevant documents to the query based on the indexing of the corpora of curated facts, which is then augmented with the deep representation of the query using an encoder transformer architecture, that is then used for retrieving a part of the document or generating a novel response to the user query, using a decoder transformer architecture. In some implementations, the encoder-decoder transformer architecture may be backpropagating to the neural retriever, and in some implementations, it may be taking the retriever as non-parametric memory. The neural semantic parser 406 is the next module that answers the query based on the existing structured datasets. The neural semantic parser 406 is coupled to receive teaching actions and instances from the human-in-the loop ML 206 and the external data and/or schema from the AI enable distributed deep semantic data compositor 214, in addition to the text query from the query rewriter 403. The neural semantic parser 406 performs deep natural language understanding grounded in the underlying datasets by learning to link the incoming text query tokens to the matches against the schema and particular values present in the datasets. One implementation of the neural semantic parser 406 transforms the linked tagged query into a vector representation using an encoder transformer architecture that is then used for generating the corresponding executable program using a decoder transformer architecture. This module also provides provenance for its decisions by its grounding in the underlying data. The neural semantic parser 406 is capable of generating any domain-specific programming language such as SQL or any general-purpose programming language such as Python, depending on the needs. The deep information retrieval module 408 is coupled to receive teaching actions and instances from the human-in-the loop ML 206, in addition to the text query from the query rewriter 403. The deep information retrieval module 408 performs multimodal similarity search for the query against all the data records available to the system, tuned to have the highest recall and hence the lowest precision. In some implementations, the deep information retrieval module 408 is a Siamese network that learns to represent a textual query close to its most relevant multimodal documents in the high-dimensional space. Hence, given an input query from the user, this module 406 can efficiently retrieve the most relevant data records, which gets sent to the dialog manager 410. The dialogue manager 410 is responsible for managing the state and flow of the interaction with the user, as well as combining the results from the specialized modules 404, 406, and 408. The dialogue manager 410 then provides an output to the natural language generation module 412. The natural language generation module 412 also receives from the distributed runtime engine 208 the execution results from executing the executable program sent by the dialog manager 410. The natural language generation module 412 uses an encoder transformer architecture to encode both the query and a summary of the execution results, and uses a transformer decoder to generate a coherent textual verbalization of the system response. This generated text is then handed to the speech synthesis module 412 to be converted into voice. The voice response, along with other text and data results, become incorporated as part of a coherent natural language data report. The ultimate natural language data report is provided back to the AI-enabled visualization & reporting engine 202 for presentation to the user 118.

Referring back to FIG. 2B, the interaction of the human-in-the-loop ML module 206 with other components of the domain general AI platform or system 150 is described. The human-in-the-loop ML module 206 is coupled to receive requests for teaching actions and/or instances and send in response teaching actions and/or instances to and from the natural language AI engine 204. The human-in-the-loop ML module 206 is also coupled to receive requests for and send in response teaching actions and/or instances to one from the AI-enabled distributed deep semantic data compositor 214. The human-in-the-loop ML module 206 is particularly advantageous because it implements a holistic human-in-the-loop machine learning paradigm, including both machine teaching and active learning. The machine teaching AI paradigm combines the power of an intelligent human in the loop, as the teacher, with an AI system that learns to improve over time through efficiently interacting with its teacher. The teacher in the loop has some basic understanding of the capabilities and prior learnings of the model that it is interacting with and is meant to provide some minimal supervision over the work of the domain general AI platform or system 150, as well as provide feedback on errors and mistakes. This paradigm is augmented with active learning, where the domain general AI platform or system 150 can interactively query a user (a teacher, who may or may not have any understanding of the capabilities and prior training of the model under the hood) for further supervision on select inquiries. This helps with the robustness and general data-efficiency of our AI training. Through this efficient human-in-the-loop paradigm, our domain-general AI platform can be finetuned for a new domain with minimal training instances and in a short period of time.

Referring now also to FIG. 5, an example implementation for the human-in-the-loop ML module 206 is described. As shown in FIG. 5, the human-in-the-loop ML module 206 is also coupled to receive human annotation from any number of humans that have different roles and expertise. For example, those roles may include an average user, a crowd worker, trained crowd worker, domain expert, a model expert, or various other human users. Any one of these humans may be considered teachers as it has been described above. For the roles that involve training, specific training instructions and qualification tests get designed for ensuring quality in teaching actions and instances. The human-in-the-loop ML module 206 uses various statistical algorithms for vetting and aggregating teaching actions/instances as they get collected, for further ensuring the quality and accuracy. The human-in-the-loop ML module 206 can be used for training machine learning models using any number of specific constructs. For example, it should be understood that other forms of machine learning other than those specified could be used including, but not limited to, geometric systems like nearest neighbors and support vector machines, probabilistic systems, evolutionary systems like genetic algorithms, decision trees, neural networks, convolutional neural networks, associated with decision trees, Bayesian inference, random forests, boosting, logistic regression, faceted navigation, query refinement, query expansion, singular value decomposition, Markov chain models, and the like. Moreover, the human-in-the-loop ML module 206 or its components may power supervised learning, semi-supervised learning, or unsupervised learning for building, training and re-training the machine learning systems based on the type of data available and the particular machine learning technology used for implementation. Additionally, the human-in-the-loop ML module 206 may include various other components such as a deployment module 502, an evaluation module 504, a generalization module 506, a collection module 508 and an instantiation module 510 to implement the process described below for continually improving the operation and accuracy of the natural language AI engine 204 and the AI enable distributed deep semantic data compositor 214 by sending requests for teaching actions or instances and receiving in response teaching actions or instances. The human-in-the-loop ML module 206 is particularly advantageous because it provides the ability to take human feedback into account to improve the operation of the domain general AI platform or system 150. In some implementations, the human-in-the-loop ML module 206 may be used to control behavior by taking feedback into account and have guarantees for generating (or not generating) a particular output given a particular input.

As shown in FIG. 5, the human-in-the-loop ML module 206 trains a ML model and deploys 502 that model in the real world for evaluation. For example, the AI model may be deployed as part of the natural language AI engine 204. As the AI model operates in a specified setting, the human-in-the-loop ML module 206 evaluates 504 of the model's accuracy and collects failure cases. Based on the evaluation and collected failure cases, the human-in-the-loop ML module 206 determines 506 a generalized teaching set. These generalized teaching sets include general (class level, as opposed to specific instance level) templates for training actions. Using the generalized teaching templates, the human-in-the-loop ML module 206 collects 508 generalized teaching actions and/or instances. Based on the needs of the domain general AI platform or system 150, the human-in-the-loop ML module 206 automatically instantiates 510 specific teaching actions and/or instances and provides them to the natural language AI engine or the AI-enabled distributed deep semantic data compositor 214.

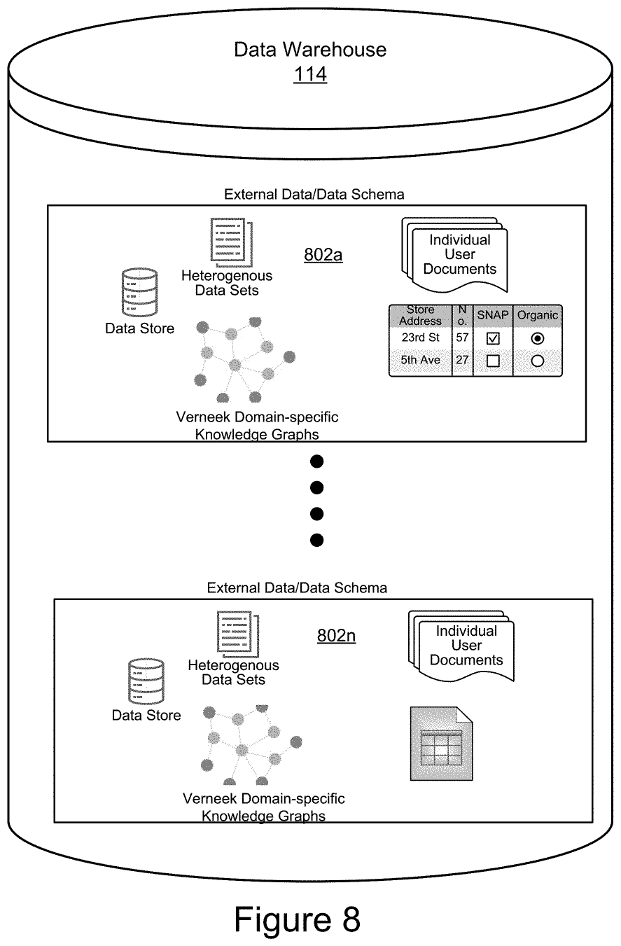

Referring back to FIG. 2B, the interaction of the distributed runtime engine 208 with other components of the domain general AI platform or system 150 is described. As has been described above, the distributed runtime engine 208 is coupled to receive an executable program from the natural language AI engine 204 and send an execution result back to the natural language AI engine 204. The distributed runtime engine 208 is also coupled to receive structured data and/or schema from the AI-enabled distributed deep semantic data compositor 214. The distributed runtime engine 208 offers implicit data parallelism and fault tolerance. and is responsible for running the executable program on top of heterogeneous sources of data which can be located anywhere, have it any format, come in any size (ranging from megabytes to terabytes of data and beyond). These sources of data are stored in the data warehouse 114 as will be described in more detail below with reference to FIG. 8. In some implementations the distributed runtime engine 208 supports optimal data processing and interoperability enabling the domain general AI platform 150 to scale. In some implementations, the distributed runtime engine 208 may be a general-purpose distributed data processing engine, for example, Apache Spark with a resilient distributed data set (RDD).

Referring now also to FIG. 6, an example implementation for the distributed runtime engine 208 is described. In some implementations, the distributed runtime engine 208 comprises a distributed execution engine 602, a semantic indexing module 604, and the function locator 606. The distributed execution engine 602 receives the executable program from the natural language AI engine 204 or the AI-enabled block-world graphical user interface 210, both of which generate similar programs either through natural language or block diagrams. The distributed execution engine 602 is also coupled to the function locator 606 to receive functions necessary to execute the program. The functions correspond to functions called the in the code of the executable program. The distributed execution engine 602 is also coupled to receive the data to the process from the semantic indexing module 604. Using the executable program, functions and data, the distributed execution engine 602 is able to run the executable program to generate an execution result. The execution result is provided back to natural language AI engine 204 or the AI-enabled block-world graphical user interface 210. The semantic indexing module 604 is coupled to receive structured data and a schema from the AI-enabled distributed deep semantic data compositor 214 and provide a fast and efficient access to each individual data record. For example, each set of structured data and schema may be related to a different domain, thereby allowing the same underlying distributed runtime engine 208 to operate across different data domains by virtue of delivering different executable programs, functions and data sets. The function locator 606 receives function signatures from the function module 212. The function locator 606 determines the list and network location of the functions needed to execute the program based on the function signature. The function locator 606 retrieves these functions and provides them to the distributed execution engine 602. Note that these functions are sometimes called through various APIs and sometimes accessed through remote procedure calls, among others.

Referring back to FIG. 2B, the interaction of the AI-enabled block-world graphical user interface 210 with other components of the domain general AI platform or system 150 is described. The AI-enabled block-world graphical user interface 210 is coupled to provide the executable program to the distributed runtime engine 208, and after execution, receives the execution result from the distributed runtime engine 208. The AI-enabled block-world graphical user interface 210 is also coupled to receive user interactions and send responses to the AI-enabled visualization & reporting engine 202. The AI-enabled block-world graphical user interface 210 is also coupled to provide the data report to the AI-enabled visualization & reporting engine 202. In some implementations, the AI-enabled block-world graphical user interface 210 is software and routines for creating any complex data flow for ingestion of data or other custom functionality to be performed by the distributed runtime engine 208. In some implementations, the AI-enabled block-world graphical user interface 210 provides an organizational structure of reusable and interoperable blocks of code for any data ingestion or classification, or processing. For example, the AI-enabled block-world graphical user interface 210 can create classic Extraction Transformation Loading (ETL) pipelines or putting together repeatable workflows for building projection models, etc. Some examples of these basic building blocks include: a data cleaning block that automatically performs a particular deletion or insertion action on selected data records, or a time series prediction block that automatically predicts future events given a series of historical events and selected covariate time series, or a basic math block such as subtraction or multiplication that can be applied to selected data records. The AI-enabled block-world graphical user interface 210 advantageously allows seamlessly ingesting private/public data sources across different domains. In addition, the AI-enabled block-world graphical user interface 210 generates and presents intuitive graphical user interfaces (GUI) for performing the operations described above and interacting with the user in a seamless and easy-to-use manner.

As also shown in FIG. 2B, the function module 212 is provided and is coupled to provide a function signature to the distributed runtime engine 208. In some implementations, the function module 212 is a data and function marketplace. The function module 212 allows users or algorithms to pull the latest available data or algorithmic blocks (functions, which could be domain-specific or domain-general) from public and private channels. The data resources and algorithmic blocks are readily available and provided by the function module 212 for incorporation into execution of the distributed runtime engine 208. This function module 212 is particularly advantageous for scalability where crowdsourcing of new data resources and algorithmic blocks will be feasible by the power of the community of users thereby making all those functions and algorithmic blocks available for use in the distributed runtime engine 208.

Finally, as also shown in FIG. 2B, the interaction of the AI-enabled distributed deep semantic data compositor 214 is described. As has been noted above, the AI-enabled distributed deep semantic data compositor 214 receives and sends teaching actions and instances to and from the human-in-the-loop ML module 206. The AI-enabled distributed deep semantic data compositor 214 is also coupled to provide a curated corpus of facts to the natural language AI engine 204. The AI-enabled distributed deep semantic data compositor 214 also provides structured data and a schema to both the natural language AI engine 204 and the distributed runtime engine. The AI-enabled distributed deep semantic data compositor 214 is coupled to receive a domain and data selection from the AI enabled visualization & reporting engine 202. The AI-enabled distributed deep semantic data compositor 214 is also coupled to receive external data from the data warehouse 114. The AI-enabled distributed deep semantic data compositor 214 is particularly advantageous because it enables the ability to work across domains, needing only minimal training from one domain to another. Based on domain and data selection, the AI-enabled distributed deep semantic data compositor 214 is able to generate a curated corpus of facts, curated knowledge graphs, structured data, schema for use by the other components of the domain general AI platform 150. The AI-enabled distributed deep semantic data compositor 214 receives teaching actions from the Human-in-the-loop Machine Learning 206 module to learn various transformation, extraction, and summarization techniques.

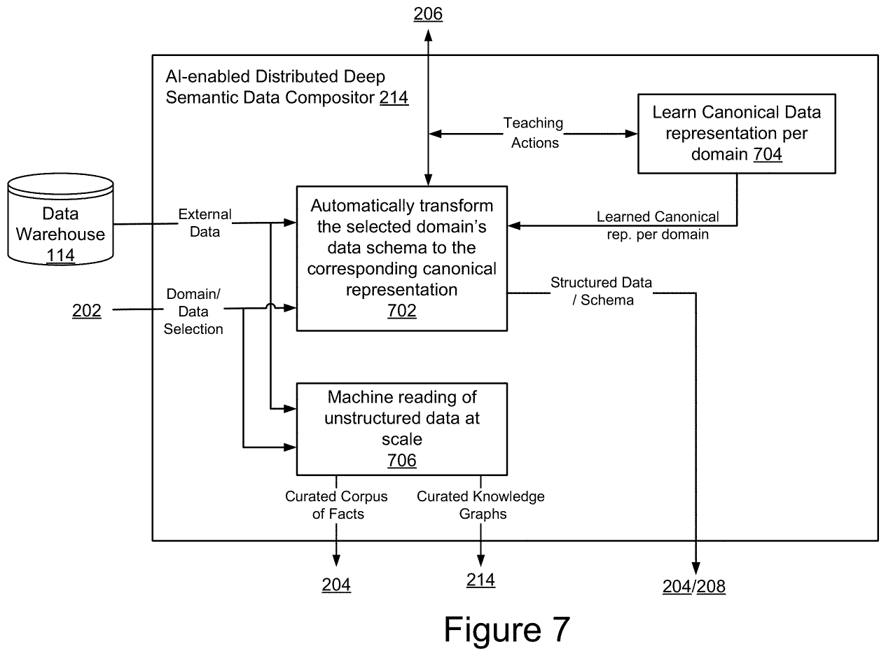

Referring now also to FIG. 7, an example implementation for the AI-enabled distributed deep semantic data compositor 214 will be described. In some implementations, the AI-enabled distributed deep semantic data compositor 214 comprises a representation learning module 704, a transformation module 702, and machine reading module 706. As shown in FIG. 7, the representation learning module 704 is coupled to receive teaching actions from the human-in-the-loop ML module 206. The coupling between the representation learning module 704, the transformation module 702 and the human-in-the-loop ML module 206 are illustrated in FIG. 7 as bi-directional to indicate that the learning module 704 and the transformation module 702 request teaching actions or instances from the human-in-the-loop ML module 206 and the human-in-the-loop ML module 206 sends the teaching actions or instances back to the module 702, 704 that requested them. The representation learning module 704 learns the canonical data representation for a given domain. For example, in the food retail domain, it automatically parses through various data schemas of grocery store product assortments and finds commonalities for composing the most efficient representation. Then, the representation learning module 704 provides the learned canonical representation of a given domain to the transformation module 702. The transformation module 702 is also coupled to send and receive the teaching actions to and from the human-in-the-loop ML module 206. This module 702 learns transformation functions that can automatically transform a given data schema to a canonical data schema, with minimal data loss. The transformation module 702 is also coupled to receive external data from the data warehouse 114. The transformation module 70 is also coupled to receive a domain and data selection from the AI-enabled visualization & reporting engine 202. Based on the domain and data selection received from the AI-enabled visualization & reporting engine 202, the transformation module 702 produces the ultimate structured data along with its schema which it outputs to the natural language AI engine 204 and the distributed runtime engine 208. Like the transformation module, the machine reading module 706 is also coupled to receive external data from the data warehouse 114, and to receive a domain and data selection from the AI-enabled visualization & reporting engine 202. The machine reading module 706 is tasked with automatically reading unstructured web-scale corpora to transform them into semi-structured data records. This module 706 processes the selected domain and the data selected, and automatically parses all the external data corresponding to those choices. The machine reading module 706 then generates a curated corpus of facts by machine reading the unstructured data at scale received from the data warehouse 114. The machine reading module 706 also generates curated domain-specific and domain-general knowledge graphs through Automatic Knowledge Base Completion (AKBC) techniques. The machine reading module 706 provides this curated corpus of facts to the natural language AI engine 204. Furthermore, the machine reading module 706 automatically populates curated knowledge graphs through using Automatic Knowledge Base Construction (AKBC) AI algorithms. For instance, in the domain of health and nutrition, the automatically constructed knowledge graph will have nodes representing food items or particular diets and with the edges signifying various relationships between the nodes, such as “allows” or “prohibits”. As another example, in the domain of retail, one knowledge graph can include nodes representing products in the US market with varying degrees of specificity, with “is-a ” relationship defining the type hierarchy of products. The machine reading module 706 is coupled to the data warehouse 114 to store the curated knowledge graphs therein.

FIG. 8 shows an example implementation for the data warehouse 114 in accordance with the present disclosure. While the data warehouse 114 is shown as a single database in FIG. 8, it should be understood that the data warehouse could be a plurality of different databases, data stores and also could be distributed amongst various locations, the cloud and other physical data storage locations. As shown in FIG. 8, the data warehouse 114 includes one or more external data and data schema sets. In particular, FIG. 8 illustrates n number of external data and data schema sets. Each external data and data schema set may include one or more of data stores, heterogeneous data sets, individual user documents, additional tables or indexes, and domain-specific knowledge graphs. For example, differences of users may create different external data and data schema sets where the data is segregated by domain, subject matter, industry type, or any other categorization. For example, the set of data for the domain of healthcare could include drug-drug interaction databases, USDA nutritional information on food items, databases of FDA approved drugs and their attributes, Medicare and Medicaid data records, corpus of most frequently asked medical questions, and knowledge graph of diseases associated with symptoms and efficacious drugs, among others. As noted above, there may be different domains such as retail, financial, computing, engineering, construction, research, pharmacy, medical, automobile, etc. For each of these different domains they each may have a corresponding external data and data schema sets. Additionally, the domain general AI platform or system 150 has domain generality so that it may both work across different domains as well as improve the AI across different domains and reduce the amount of training from one domain to another.

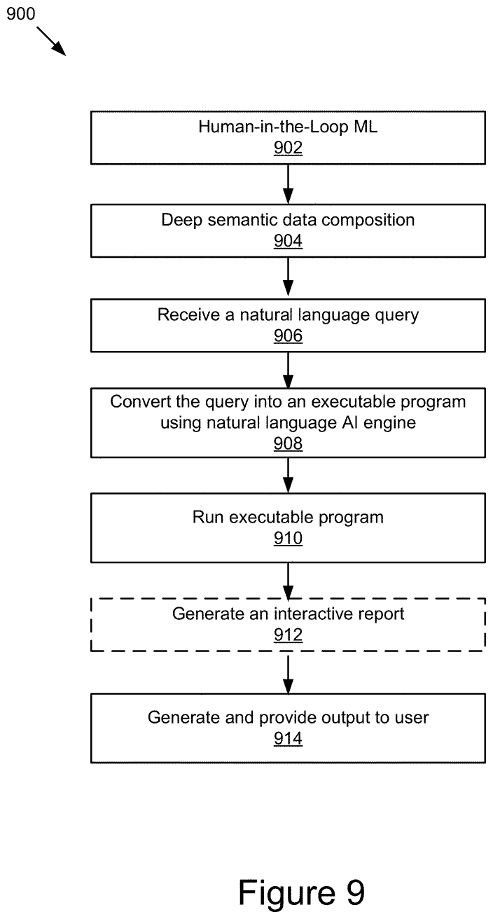

Referring now to FIG. 9, a flowchart of an example method 900 for data informed decision-making in accordance with the present disclosure will be described. The method 900 begins with human-in-the-loop machine learning 902 as has been described above. It should be understood that the human-in-the-loop machine learning 902 is involved in various of the following blocks 904 to 914 as will be described in more detail below. However, it has been placed at the beginning of method 900 so that users will understand that the human-in-the-loop machine learning process may provide input into any one of the following steps. Examples of human-in-the-loop machine learning 206 have been described above with reference to FIG. 5. Next, the method 900 performs 904 deep semantic data composition. In some implementations, this includes ingesting private/public data sources across different domains. In some implementations, this is performed by the AI-enabled distributed deep semantic data compositor 214 as has been described above. Then the method 900 receives 906 a natural language query from a user for performing a decision-making action. In some implementations, the natural language query can be natural language text input by user, natural language speech or sound input by user, or a combination of both. The method 900 continues by converting 908 the query into an executable program using the natural language AI engine 204 or the AI-enabled block world graphical user interface 210. Next, the method 900 runs 910 the executable program. In some implementations, the executable program is run by the distributed runtime engine 208. The method 900 then generates 912 an interactive report. This step is illustrated in FIG. 9 with dashed lines to indicate that this step is optional. The method 900 continues by generating and providing 914 the output to the user based on the query and the execution of the program.

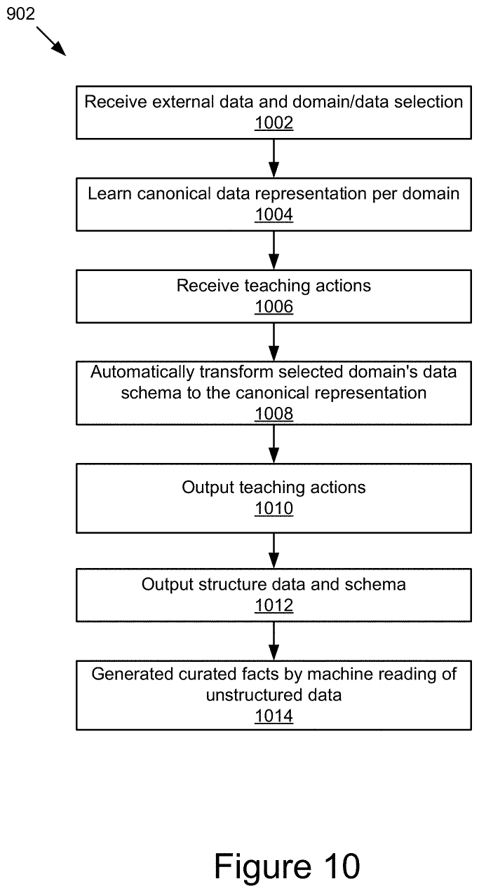

Referring now to FIG. 10, an example method 902 for deep semantic data composition according to some implementations will be described. The method 902 begins by receiving 1002 external data and domain selection. The external data can be received from the data warehouse and the data and domain selection can be received from the user via the AI-enabled visualization & reporting engine 202. Next, the method 902 learns 1004 or determines a canonical data representation per domain. In some implementations, the canonical data representations may be created prior to selection of a domain by the user. In other implementations, the can article data representation is created only for the dated and domain selected by the user in block 1002. The method 902 continues by receiving 1006 teaching actions from the human-in-the-loop ML module 206. Then, the method 902 automatically transforms the selected data schema of the domain to the canonical representation. Next, the method 902 outputs 1010 teaching actions. Then method 902 outputs 1012 the structure data and schema to the natural language AI engine 204 and the distributed runtime engine 208. Finally, the method 902 generates 1014 a curated corpus of facts by machine reading the unstructured data and outputs the curated corpus of facts to the natural language AI engine 204.

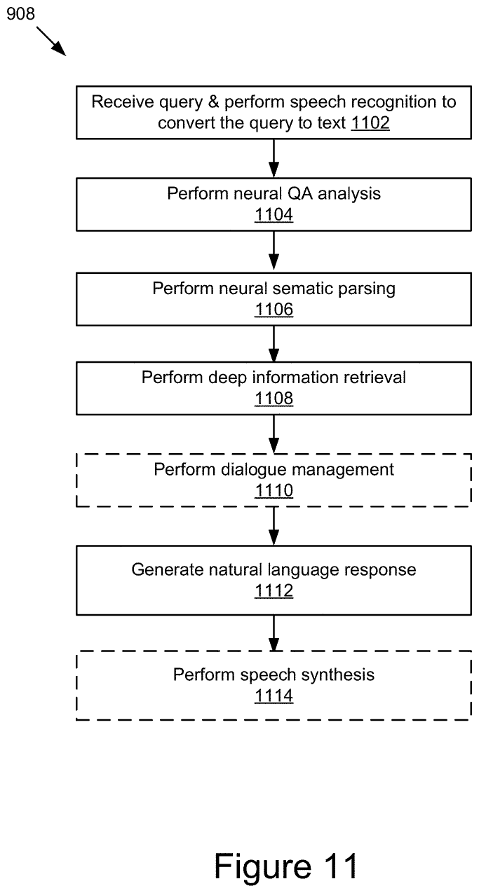

FIG. 11 shows an example method 908 for converting a query into executable code using machine learning according to some implementations. The method 908 begins by receiving a query 1102 and performing speech recognition, if necessary, to convert the query to text. In some implementations, the method 908 receives the query as all text input and performing speech recognition is not required. However, where any portion of the query is either speech input alone or a combination of text input and speech input, then performing speech recognition as indicated in block 1102 is required. Next, the method 908 performs 1104 neural question answering (QA) analysis. For example, this may be performed using the neural QA system 404 described above. Then, the method 908 performs 1106 neural semantic parsing on the results of the neural QA analysis. The method 908 continues by performing 1108 deep information retrieval using the results from the neural semantic parsing to generate an executable program. Next, the method 908 performs 1110 dialog management. As depicted in FIG. 11, this block is optional and shown with dashed lines to indicate such. The method 908 continues by generating 1112 a natural language response based upon an execution result generated by execution of the executable program produced from deep information retrieval. If necessary, the method 908 performs speech synthesis on the natural language response. Similar to the input, if the output is text only, this block is optional and is depicted with dashed lines. However, if part of the natural language response includes speech or audio, the natural language response must be synthesized to produce that audio output.

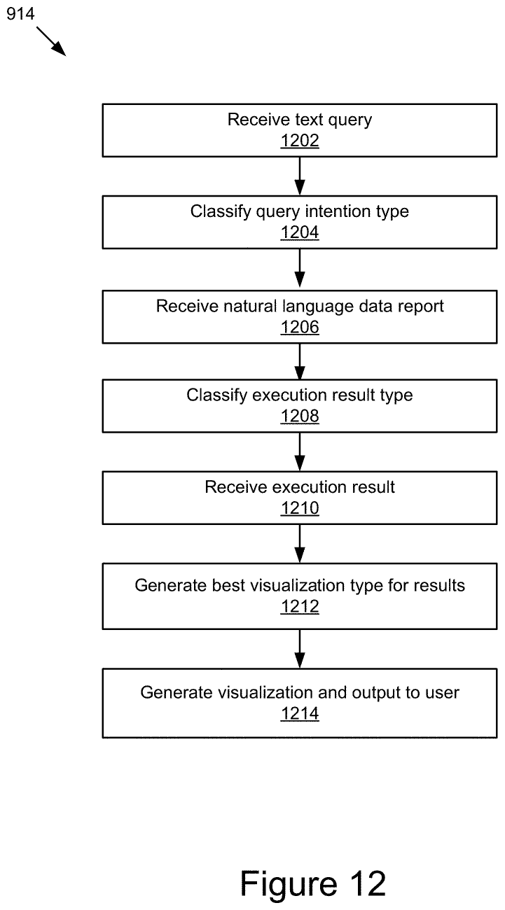

FIG. 12 shows an example method 914 for AI-enabled visualization in accordance with some implementations. The method 914 begins by receiving 1202 a text query. Next, the method 914 classifies 1204 the query intention type. Then method 914 receives 1206 a natural language data report. The method 914 then classifies 1208 an execution result type. Next, the method 914 receives 1210 an execution result. Then the method 914 generates 1212 a best visualization type for the results based upon the intention type, the natural language data report, the execution type, and the execution result. In one example, the underlying model for method 914 is an encoder-decoder transformer architecture that, given all the input, generates an abstract semantic tree corresponding to the most appropriate JSON visualization with all the attributes and values. Finally, the method 914 generates a visualization using the visualization type identified in block 1212 and outputs the visualization to the user.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), Web Socket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies, engines, and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer implemented method comprising:
receiving, using one or more processors, a natural language query;
converting, using one or more processors, the natural language query into executable code grounded in deep semantic understanding of data using an artificial intelligence engine;
running, using one or more processors, the executable code;
generating an output based upon running the executable code; and
providing the output to a user.

2. The method of claim 1, wherein the natural language query includes one or more of text, speech or text and speech.

3. The method of claim 1, further comprising:
receiving a selection of a domain from the user;
receiving external data; and
performing deep semantic data composition using the selection of the domain and the external data.

4. The method of claim 3, wherein performing deep semantic data composition comprises:
determining a canonical data representation for the selection of the domain;
receiving one or more teaching actions;
automatically transforming a data schema of the selection of the domain to the canonical data representation using the one or more teaching actions;
outputting structured data and the transformed schema; and
generating curated facts and knowledge graphs by machine reading of unstructured data at scale.

5. The method of claim 4, wherein outputting teaching actions includes generating specific teaching actions or instances using human-in-the-loop machine learning.

6. The method of claim 1, wherein converting the natural language query into executable code comprises:
performing neural question answering given the natural language query;
performing neural semantic parsing given the natural language query;
performing deep information retrieval given the natural language query; and
generating an ultimate natural language response from an aggregate.

7. The method of claim 6, further comprising:
performing dialogue management on the neural question answering, neural semantic parsing, and deep information retrieval outputs to determine a most appropriate aggregate response to the natural language query; and
performing natural language generation to generate a coherent verbalization of the natural language response; and performing speech synthesis on the coherent verbalization of the response.

8. The method of claim 7, wherein converting the natural language query into executable code comprises performing speech recognition on the natural language query to generate text.

9. The method of claim 1, wherein generating an output based on running the executable code further comprises:
receiving a text query based on the natural language query;
classifying a query intention type for the text query;
receiving a natural language data report;
classifying an execution result type based on the natural language data report;
receiving an execution result;
generating a visualization type based on the execution result and the execution result type; and
generating a visualization based upon the visualization type and the execution result.

10. The method of claim 1, wherein generating the output includes generating an interactive report.

11. A system comprising:
one or more processors; and
a memory storing instructions, which when executed cause the one or more processors to perform operations including:
receiving a natural language query;
converting the natural language query into executable code grounded in a deep semantic understanding of data, using an artificial intelligence engine;
running the executable code;
generating an output based upon running the executable code; and
providing the output to a user.

12. The system of claim 11, wherein the natural language query includes one or more of text, speech or text and speech.

13. The system of claim 11, wherein the memory also stores instructions, which when executed cause the one or more processors to perform the operations of:
receiving a selection of a domain from the user;
receiving external data; and claimed
performing deep semantic data composition using the selection of the domain and the external data.

14. The system of claim 13, wherein the memory also stores instructions, which when executed cause the one or more processors to perform the operations of:
learning a canonical data representation for the selection of the domain;
receiving one or more teaching actions;
automatically transforming a data schema of the selection of the domain to the canonical data representation using the one or more teaching actions;
outputting structured data and the transformed schema; and
generating curated facts and knowledge graphs by machine reading of unstructured data.

15. The system of claim 14, wherein outputting teaching actions includes generating specific teaching actions or instances using human-in-the-loop machine learning.

16. The system of claim 11, wherein the memory also stores instructions, which when executed cause the one or more processors to perform the operations of:
performing neural question answering given the natural language query;
performing neural semantic parsing given the natural language query;
performing deep information retrieval given the natural language query; and
generating an ultimate natural language response from an aggregate.

17. The system of claim 16, wherein the memory also stores instructions, which when executed cause the one or more processors to perform the operations of:
performing dialogue management on neural question answering, neural semantic parsing, and deep information retrieval outputs to determine a most appropriate aggregate response to natural language the query; and
performing natural language generation to generate a coherent verbalization of the natural language response; and
performing speech synthesis on the coherent verbalization of the response.

18. The system of claim 17, wherein converting the natural language query into executable code comprises performing speech recognition on the natural language query to generate text.

19. The system of claim 11, wherein the memory also stores instructions, which when executed cause the one or more processors to perform the operations of:
receiving a text query based on the natural language query;
classifying a query intention type for the text query;
receiving a natural language data report;
classifying an execution result type based on the natural language data report;
receiving an execution result;
generating a visualization type based on the execution result and the execution result type; and
generating a visualization based upon the visualization type and the execution result.

20. The system of claim 11, wherein generating the output includes generating an interactive report.
